(19) United States
(12) Patent Application Publication
(10) Pub. No.: US 2026/0044980 A1
(43) Pub. Date: Feb. 12, 2026

(54) PROCESSING APPARATUS AND PROCESSING METHOD

(71) Applicant: Panasonic Intellectual Property Management Co., Ltd., Osaka (JP)

(72) Inventor: Ryo FUJITA, Hyogo (JP)

(21) Appl. No.: 19/358,896

(22) Filed: Oct. 15, 2025

Related U.S. Application Data
(63) Continuation of application No. PCT/JP2024/011091, filed on Mar. 21, 2024.

(30) Foreign Application Priority Data
Apr. 28, 2023 (JP) 2023-075313

(51) Int. Cl. G06T 7/70; G02B 5/04; G06V 10/141; H04N 23/55; H04N 23/90

(52) U.S. Cl. CPC G06T 7/70; G02B 5/04; G06V 10/141; H04N 23/55; H04N 23/90

(57) ABSTRACT

A processing apparatus includes a positioning device, a head, and a stage. The positioning device includes a camera, a prism, and computation equipment, and the prism includes a first reflection surface and a second reflection surface. When the prism is disposed between the head and the stage, the first reflection surface reflects light incident from the direction of the head toward the camera, and the second reflection surface reflects light incident from the direction of stage toward the camera. On the basis of light incident from the prism, the camera captures a camera image including a first image that is an image of the side where the head is located and a second image that is an image of the side where the stage is located. The computation equipment determines the position of a first member and the position of a second member on the basis of the camera image.

### CROSS REFERENCE TO RELATED APPLICATIONS

This is a continuation application of PCT International Application No. PCT/JP2024/011091 filed on Mar. 21, 2024, designating the United States of America, which is based on and claims priority of Japanese Patent Application No. 2023-075313 filed on Apr. 28, 2023. The entire disclosures of the above-identified applications, including the specifications, drawings and claims are incorporated herein by reference in their entirety.

### FIELD

The present disclosure relates to, for example, a processing apparatus and a processing method used in performing positioning between members.

### BACKGROUND

Conventionally, in manufacturing, for example, an electronic component, the positions of members, such as a substrate and a chip component are identified by using a camera, and positioning of each member is performed. At this time, movement to correct the position deviation of each member is performed according to the position deviation amount recognized by the camera. Here, a movement error can be decreased by minimizing the movement of a head and a stage after the recognition and correction.

For instance, in Patent Literature (PTL) 1, a member is positioned directly above a mounting position on a substrate, and PTL 1 uses an optical system capable of recognizing an alignment mark on the back surface of a member and an alignment mark on the front surface of a member, the back surface and the front surface being to be connected to each other. Specifically, in PTL 1, an optical system for an upper field of view that images the alignment mark on the back surface of the member and an optical system for a lower field of view that images the alignment mark on the front surface of the member are separate structures. Thus, the optical axis of the upper field of view and the optical axis of lower field of view are coaxial with each other after light reflection at a prism, which enables imaging of the upper field of view and the lower field of view along the same axis. In the above configuration, by aligning the horizontal positions of the two members on the basis of the information captured by the optical systems, the two members can be connected to each other only by a downward movement operation of a head. This can minimize an error due to device movement, which enables mounting with high accuracy.

### CITATION LIST

### Patent Literature

PTL 1: Japanese Patent No. 4642565

### SUMMARY

### Technical Problem

However, in performing positioning with ultra-high precision of less than or equal to 10 μm, a deviation occurs in an optical path due to just a little thermal expansion of some or multiple components, such as a prism, a mirror, and a camera, among the components of an optical system for a first member and an optical system for a second member. Thus, the optical path of the optical system for the first member and the optical path of the optical system for the second member no longer share the same axis, which deteriorates the positioning accuracy.

In view of this, the present disclosure provides, for example, a processing apparatus and a processing method that are capable of suppressing the positioning accuracy from decreasing.

### Solution to Problem

A processing apparatus according to an embodiment of the present disclosure includes: a head; a stage; a positioning device that performs positioning of a first member held by the head and a second member held by the stage when connecting the first member to the second member; a prism including a first reflection surface and a second reflection surface; a camera; and computation equipment. When the prism is disposed between the head and stage, the first reflection surface reflects light incident from a direction of the head toward the camera, and the second reflection surface reflects light incident from a direction of the stage toward the camera. Based on light incident from the prism, the camera captures a camera image including a first image that is an image of a side where the head is located and a second image that is an image of a side where the stage is located. The computation equipment determines, based on the camera image, a position of the first member and a position of the second member.

### Advantageous Effects

In the present disclosure, it is possible to suppress the positioning accuracy from decreasing.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a configuration of a processing apparatus according to Embodiment 1.

FIG. 2 illustrates some of the processes of an operation procedure when the processing apparatus according to Embodiment 1 is used as an imprint apparatus.

FIG. 3 is a side view of a positioning device according to Embodiment 1.

FIG. 4 is a flowchart for explaining an operation of the positioning device according to Embodiment 1.

FIG. 5 is a flowchart illustrating processing for calculating a position correction amount according to Embodiment 1.

FIG. 6 is a figure for explaining the processing for calculating the position correction amount according to Embodiment 1.

FIG. 7 is a figure for explaining the processing for calculating the position correction amount according to Embodiment 1.

FIG. 8 is a flowchart illustrating processing for correcting a boundary position according to Embodiment 2.

FIG. 9 is a figure for explaining the processing for correcting the boundary position according to Embodiment 2.

FIG. 10 is a side view of a positioning device according to Embodiment 3.

FIG. 11 is a figure for explaining another example of a prism according to Embodiment 3.

FIG. 12A is a side view of another example of the positioning device according to Embodiment 3.

FIG. 12B is a side view of still another example of the positioning device according to Embodiment 3.

FIG. 13 is a side view of yet another example of the positioning device according to Embodiment 3.

FIG. 14 is a side view of yet another example of the positioning device according to Embodiment 3.

FIG. 15 is a figure for explaining boundary detection processing of the positioning device illustrated in FIG. 12A.

FIG. 16 is a side view of yet another example of the positioning device according to Embodiment 3.

FIG. 17 illustrates a configuration of a positioning device according to another embodiment.

### DESCRIPTION OF EMBODIMENTS

Hereinafter, embodiments of the present disclosure are described with reference to the drawings. It should be noted that each of the embodiments described below indicates a specific example of the present disclosure. Thus, the numerical values, shapes, materials, constituent elements, arrangement and connections of the constituent elements, and other details described in the embodiments below are mere examples, and do not intend to limit the present disclosure. Accordingly, the constituent elements not recited in the independent claims, which indicate superordinate concepts of the present disclosure, among those described in the embodiments below are described as optional constituent elements.

Moreover, in the specification and drawings, the X-axis, the Y-axis, and the Z-axis indicate three axes in a three-dimensional orthogonal coordinate system. The X-axis and the Y-axis are orthogonal to each other, and both axes are orthogonal to the Z-axis. In the embodiments, a Z-axis direction is a vertical direction. It should be noted that the figures are schematic illustrations and are not necessarily precise depictions. Moreover, in the figures, substantially the same elements are assigned the same reference signs, and overlapping explanations are omitted or simplified.

### Embodiment 1

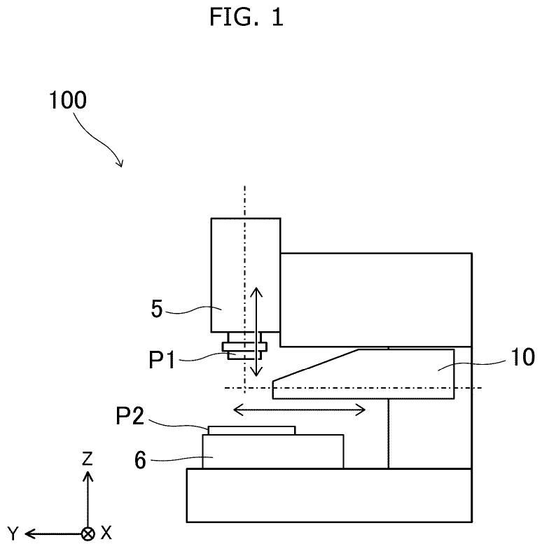

First, processing apparatus 100 according to Embodiment 1 is described with reference to FIG. 1. FIG. 1 illustrates a configuration of processing apparatus 100 according to Embodiment 1.

As illustrated in FIG. 1, processing apparatus 100 includes head 5, stage 6, and positioning device 10.

Head 5 is a holding device that holds first member P1. Head 5 can hold first member P1 by, for example, adsorbing or grasping first member P1. Moreover, by being secured with a screw, first member P1 may be held by head 5. Head 5 is movable in a Z-axis direction. Moreover, head 5 is rotatable about a Z-axis. Thus, although not illustrated in the figure, processing apparatus 100 includes a mechanism capable of moving head 5 in the Z-axis direction and rotating head 5 about the Z-axis. Moreover, head 5 may include a mechanism that enables movement in an X-axis direction and a Y-axis direction.

Stage 6 supports second member P2. Stage 6 holds second member P2. For instance, by being placed on the top surface of stage 6, second member P2 is held by stage 6. Stage 6 is movable in the X-axis direction and Y-axis direction. Thus, although not illustrated in the figure, processing apparatus 100 includes a mechanism capable of moving stage 6 in the X-axis direction and Y-axis direction.

Head 5 may perform a combinational movement including movement in the X-axis direction relative to stage 6, movement in the Y-axis direction relative to stage 6, positioning about the Z-axis, and movement in the Z-axis direction. Moreover, the transfer mechanism may be provided to either head 5 or stage 6, and may be provided to each of head 5 and stage 6.

Positioning device 10 is a positioning mechanism for performing positioning between first member P1 held by head 5 and second member P2 held by stage 6. As with stage 6, positioning device 10 is movable in the X-axis direction and Y-axis direction. Thus, although not illustrated in the figure, processing apparatus 100 includes a mechanism capable of moving positioning device 10 in the X-axis direction and Y-axis direction.

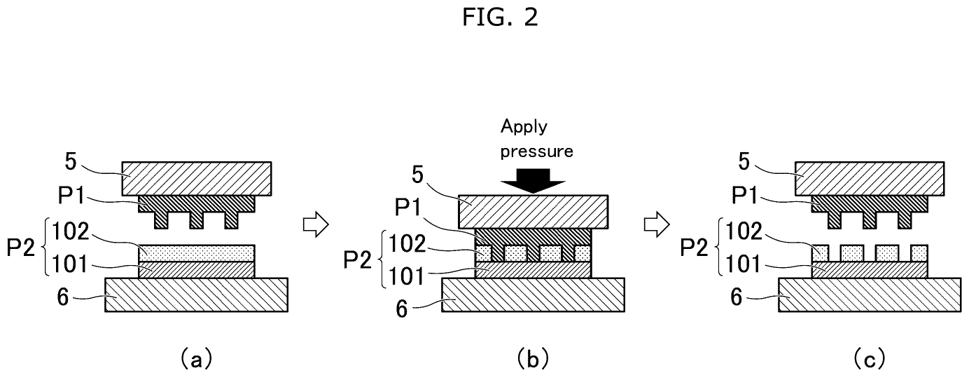

Processing apparatus 100 in Embodiment 1 is an imprint apparatus. For instance, processing apparatus 100 is a nano-imprint apparatus for forming a structure such as a nano-order sized electrode. Here, an operation procedure when processing apparatus 100 is used as an imprint apparatus is described with reference to FIG. 2. FIG. 2 illustrates some of the processes of the operation procedure when processing apparatus 100 according to Embodiment 1 is used as an imprint apparatus.

When processing apparatus 100 is an imprint apparatus, as illustrated in FIG. 2, first member P1 is an imprint mold having a structure with depressions and projections, and second member P2 is a workpiece subjected to imprinting. Second member P2 includes, for example, substrate 101 such as a silicon substrate (wafer) and resin layer 102 disposed above substrate 101.

As illustrated in (a) in FIG. 2, first member P1 is positioned on head 5, and second member P2 is positioned on stage 6. When second member P2 is positioned on stage 6, substrate 101 is placed on stage 6, for instance. Then, a resin material is applied to the top of substrate 101, thereby forming resin layer 102.

Then, the horizontal positions of first member P1 and second member P2 are corrected using positioning device 10. After that, as illustrated in (b) in FIG. 2, head 5 holding first member P1 is moved downward to press the imprint mold, which is first member P1, against resin layer 102 of second member P2. Specifically, the projections of the imprint mold are pressed against resin layer 102 of second member P2.

Then, resin layer 102 is caused to harden in a state where first member P1 is pressed against second member P2. In this case, when the resin material of resin layer 102 is a thermohardening resin, resin layer 102 hardens when heated. Meanwhile, when the resin material of resin layer 102 is a photocurable resin, resin layer 102 is cured when irradiated with light such as ultraviolet light.

Then, as illustrated in (c) in FIG. 2, head 5 holding first member P1 is moved upward to move the imprint mold, which is first member P1, away from second member P2. In this way, openings corresponding to the projections of the imprint mold are formed in resin layer 102.

It should be noted that hardening/curing of resin layer 102 is not limited to hardening/curing performed in a state where first member P1 is pressed against second member P2. Alternatively, hardening/curing of resin layer 102 may be performed after head 5 holding first member P1 is moved upward and the imprint mold, which is first member P1, is moved away from second member P2.

Then, although not illustrated in the figure, a plated film is formed to fill the openings in resin layer 102 by electroless plating. By removing resin layer 102 serving as a resist, it is possible to obtain substrate 101 above which projecting plated electrodes are formed. It should be noted that in this case, to form the metal film, a base electrode such as a seed layer is formed in advance on each of portions of substrate 101 corresponding to the openings in resin layer 102. The plated electrodes formed in this manner can be used as bumps (for example, microbumps). For instance, the substrate including the bumps (plated electrodes) are bump-bonded to a chip component such as a semiconductor chip. In this way, it is possible to obtain an electronic component in which the substrate is bump-bonded to the chip component.

It should be noted that when substrate 101 of second member P2 is, for example, a wafer and is large in comparison with first member P1, processes (a) to (c) in FIG. 2 may be repeated at two or more portions of the wafer under the same condition.

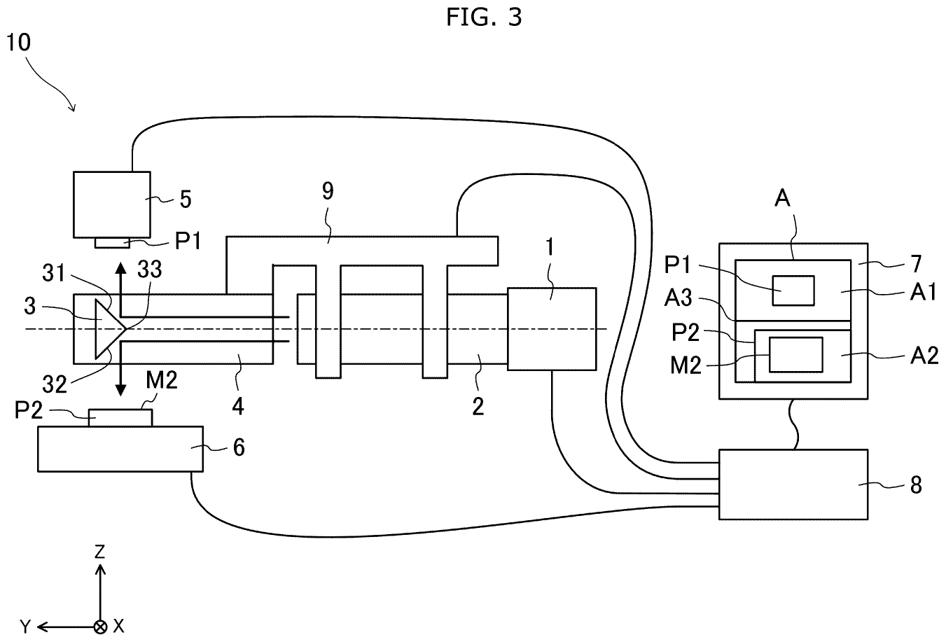

Hereinafter, a detailed configuration of positioning device 10 in processing apparatus 100 according to Embodiment 1 is described with reference to FIG. 3. FIG. 3 is a side view of positioning device 10 according to Embodiment 1. It should be noted that in the following explanation, the imaging direction of camera 1 (optical axis direction of lens 2) is a Y-direction, a vertical direction is a Z-direction (a first direction), and a direction perpendicular to the Y-direction and the Z-direction is an X-direction.

As illustrated in FIG. 3, positioning device 10 according to Embodiment 1 includes camera 1, lens 2, prism 3, prism holder 4, head 5, stage 6, monitor 7, and computation equipment 8.

Camera 1 images, via lens 2 and prism 3, first member P1 held by head 5 and second member P2 held by stage 6 (details are described later). Camera 1 outputs captured camera image A to computation equipment 8. Computation equipment 8 outputs camera image A and a calculation result to monitor 7.

Lens 2 is so attached that the optical axis thereof matches the imaging direction of camera 1. Lens 2 may be a telecentric optical system with a small positional change even if there is a slight shift in a focus position. However, this does not apply to a case where the accuracy of transferring a workpiece to a focus position is high.

Prism 3 is positioned on the optical axis of lens 2 (in the imaging direction of camera 1). Prism 3 includes first reflection surface 31 and second reflection surface 32 with boundary line 33 interposed therebetween. An angle formed between first reflection surface 31 and second reflection surface 32 is, for example, 90 degrees. Moreover, the angle of first reflection surface 31 relative to the Z-axis is 45 degrees, which enables first reflection surface 31 to reflect light incident from head 5 in the optical axis direction of lens 2. The angle of second reflection surface 32 relative to the Z-axis is 45 degrees, which enables second reflection surface 32 to reflect light incident from stage 6 in the optical axis direction of lens 2. It should be noted that the angles of first reflection surface 31 and second reflection surface 32 need not be the angles exemplified above, and may be any angles as long as the following configuration can be achieved.

For instance, lens 2 and camera 1 may be rotated by an angle of φ in a rotational direction about the X-axis, with boundary line 33 of prism 3 being the center line of rotation to make the camera 1 side have an orientation in the positive Z-direction. In this case, prism 3 may be rotated by an angle of φ/2 about the same X-axis, with boundary line 33 being the center line of rotation. In this way, it is possible to decrease the distance between first member P1 and second member P2, which makes it possible to obtain a clear image in which blur is suppressed that appears when imaging boundary line 33, which is described later. In addition, the movement of head 5 after alignment becomes smaller. Thus, even if for example the movement axis of head 5 tilts due to, for example, thermal expansion, the effects of the tilting on alignment can be suppressed.

Prism holder 4 holds prism 3. In Embodiment 1, prism 3 is attached to prism holder 4 by an adhesive agent, which enables prism holder 4 to hold prism 3. However, prism 3 may be held by another holding method (for example, by causing prism holder 4 to grasp prism 3).

As illustrated in FIG. 3, optical unit base 9 holds lens 2 and prism holder 4. It should be noted that a positioning (focus) adjustment mechanism may be provided between lens 2 and optical unit base 9. Moreover, fine positioning adjustment mechanism may be provided between prism holder 4 and optical unit base 9. Moreover, in Embodiment 1, lens 2 and prism holder 4 are both fixed by identical optical unit base 9. However, optical unit base 9 may be provided for each of lens 2 and prism holder 4.

As described above, head 5 holds first member P1, and stage 6 holds second member P2. For instance, when processing apparatus 100 is an imprint apparatus, first member P1 is an imprint mold, and second member P2 is a workpiece including a substrate. First member P1 and second member P2 are picked up by, for example, a feed head (illustration is omitted), and then held by head 5 and stage 6, respectively.

Here, a first optical path has the same length as a second optical path, the first optical path being a path from camera 1 to first member P1 on head 5 via lens 2 and first reflection surface 31 of prism 3, the second optical path being a path from camera 1 to second member P2 on stage 6 via lens 2 and second reflection surface 32 of prism 3.

Monitor 7 displays camera image A captured by camera 1. Camera image A includes first image A1 that is an image of the side where head 5 is located, and second image A2 that is an image of the side where stage 6 is located. As illustrated in FIG. 3, first image A1 and second image A2 that are vertically arranged with boundary A3 interposed therebetween are displayed. Boundary A3 is an image corresponding to boundary line 33 of prism 3. Since prism 3 is so disposed that a point on boundary line 33 is located on the optical axis of lens 2, boundary A3 is positioned at the center of camera image A.

Computation equipment 8 calculates the relative positions of first member P1 and second member P2 on the basis of camera image A output by camera 1, and performs the positioning processing described below.

It should be noted that an optical system including, for example, camera 1, lens 2, prism 3, and prism holder 4 (hereinafter, the components may be simply referred to as an optical system) is movable in the X-direction and Y-direction. Moreover, head 5 and stage 6 are movable in the X-direction, the Y-direction, and a direction of rotation about the Z-axis.

First member P1 and second member P2 (hereinafter, first member P1 and second member P2 may be each referred to as a workpiece) are disposed at the focal position of lens 2, and prism 3 is disposed between lens 2 on the optical axis and each workpiece. Thus, blur appears at boundary A3 in an obtained image. When prism 3 is close to lens 2, blur at boundary A3 in camera image A is large, which decreases the position recognition accuracy of boundary A3. In a system, which is described later, for calculating the relative positions of first member P1 and second member P2 on the basis of boundary A3, a decrease in the position recognition accuracy of boundary A3 leads to a decrease in the positioning accuracy of first member P1 and second member P2. Thus, in the present disclosure, prism 3 is disposed very close to first member P1 and second member P2 in the first optical path and the second optical path. Specifically, prism 3 is so disposed that the distance between prism 3 and each of first member P1 and second member P2 is less than the distance between prism 3 and lens 2. In this way, it is possible to decrease blur at boundary A3. Moreover, it is possible to decrease the distance between the relative positions of first member P1 and second member P2. Furthermore, by bringing prism 3 and the workpieces closer to each other, even if small angular misalignment of prism 3 occurs due to, for example, thermal strain, it is possible to minimize the effects of a position deviation of each workpiece due to misalignment in the optical axis. Thus, it is possible to eventually decrease the movement of each member after the correction, which can decrease an error in positioning correction.

### (Operation of Positioning Device)

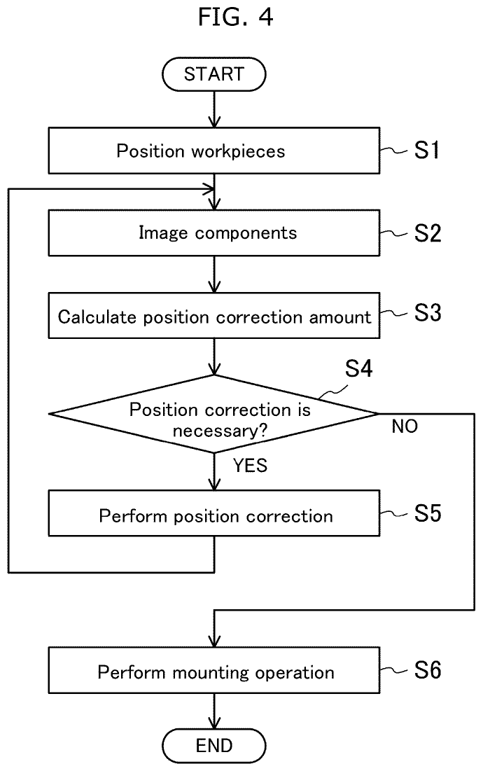

FIG. 4 is a flowchart for explaining an operation of positioning device 10 according to Embodiment 1.

First, workpieces are positioned in positioning device 10 (step S1). Specifically, by using the feed head (illustration is omitted), head 5 is caused to hold first member P1, and second member P2 is placed on stage 6. Here, an alignment point is provided on the surface of first member P1, and an alignment point is provided on the surface of second member P2. First member P1 is held by head 5 and second member P2 is placed on stage 6 such that the alignment points face each other.

Camera 1 images first member P1 and second member P2 (step S2). Specifically, camera 1, lens 2, and prism 3, and prism holder 4 are moved to dispose prism 3 between first member P1 (head 5) and second member P2 (stage 6). Then, camera 1 outputs, to computation equipment 8, camera image A showing first member P1 and second member P2. It should be noted that camera 1 may capture first image A1 and second image A2 separately or simultaneously. For instance, when first image A1 and second image A2 are captured at the same time, one of the images may turn white or black. When image capturing conditions, such as lighting luminance, shutter speed, camera gain, and the ratio of coaxial light to oblique light differ between first image A1 and second image A2, camera 1 may capture first image A1 and second image A2 separately.

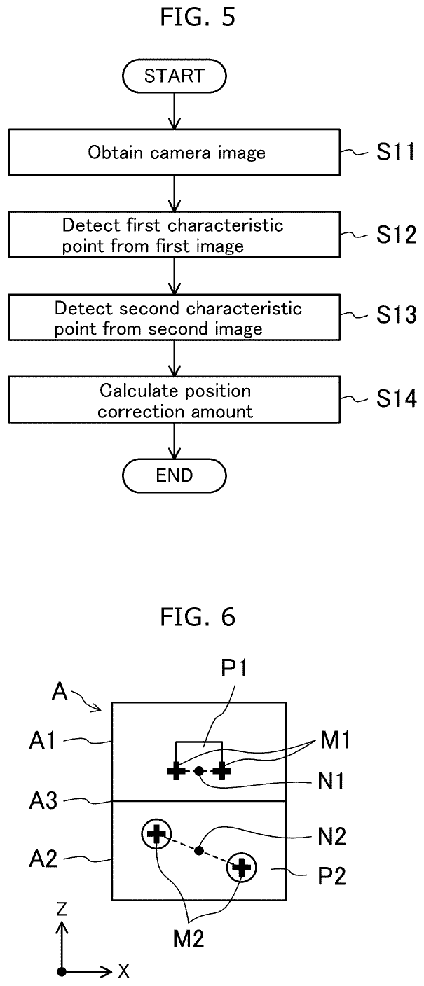

Computation equipment 8 determines the relative positions of first member P1 and second member P2 on the basis of first image A1 and second image A2 included in camera image A, and calculates the position correction amount of first member P1 and second member P2 (step S3). Specifically, the processing illustrated in FIG. 5 is performed (details are described later).

Computation equipment 8 determines whether position correction is necessary in accordance with the calculated position correction amount (step S4). When the position correction amount is greater than or equal to a predetermined value, computation equipment 8 determines that position correction is necessary (Yes in step S4), and corrects at least one of the position of first member P1 or the position of second member P2 (moves at least one of first member P1 or second member P2) in accordance with the position correction amount calculated in step S3 (step S5). Then, the procedure returns to step S2.

Meanwhile, when the position correction amount is less than the predetermined value, computation equipment 8 determines that position correction is not necessary (No in step S4), and performs a connection operation for connecting first member P1 to second member P2 (step S6). Specifically, head 5 is moved toward stage 6 in the Z-direction to connect first member P1 to second member P2.

### (Calculation of Position Correction Amount)

FIG. 5 is a flowchart illustrating processing for calculating a position correction amount according to Embodiment 1. FIG. 5 illustrates the processing that computation equipment 8 performs to calculate the position correction amount in step S3.

First, when obtaining camera image A (step S11), computation equipment 8 detects first characteristic point M1 of first member P1 from first image A1 (step S12). Moreover, computation equipment 8 detects second characteristic point M2 of second member P2 from second image A2 (step S13). Examples of the characteristic points include, for example, characteristic portions (such as corners) of the corresponding members and marks on the surfaces of the members.

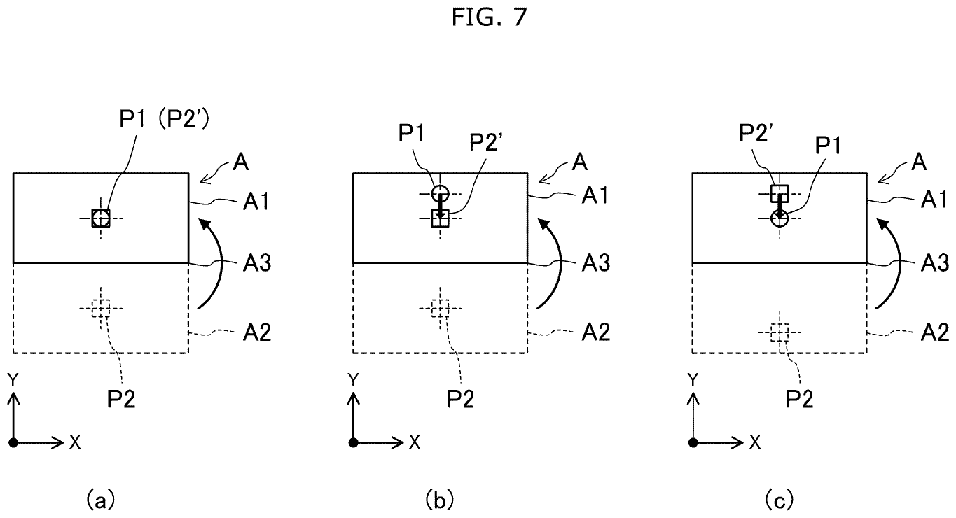

In the example indicated in FIG. 6, since a characteristic point of first member P1 is set to a corner, computation equipment 8 detects, as first characteristic point M1, the intersection point of two straight lines that form the corner. Moreover, since a characteristic point of second member P2 is set to a circular mark, computation equipment 8 detects a central part of a circle as second characteristic point M2.

In Embodiment 1, computation equipment 8 detects the middle point between two first characteristic points M1 as reference position N1 of first member P1, and the middle point between two second characteristic points M2 as reference position N2 of second member P2. Furthermore, computation equipment 8 determines a relative angle between a first angle reference line that is a straight line connecting two first characteristic points M1 and a second angle reference line that is a straight line connecting two second characteristic points M2. Computation equipment 8 calculates the position correction amount in accordance with reference position N1, reference position N2, and the relative angle between the first angle reference line and the second angle reference line (step S14).

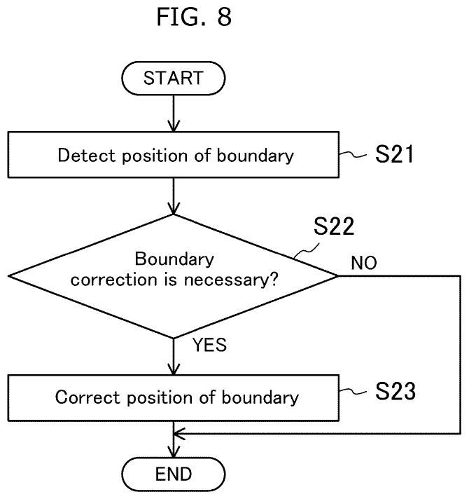

FIG. 7 is a figure for explaining the processing for calculating the position correction amount according to Embodiment 1. Each of camera images A in (a) to (c) in FIG. 7 shows first member P1 and second member P2.

As illustrated in FIG. 3, camera image A shows first image A1 and second image A2 that are vertically arranged with boundary A3, which extends in the X-direction, interposed therebetween. Here, when a relationship between each image and an actual coordinate system is considered, the X-direction in first image A1 and second image A2 is the same, and the Y-direction in first image A1 and second image A2 is inverted. That is, by folding second image A2 along boundary A3 in the Y-direction, it is possible to match the coordinates of first image A1 and second image A2 with the actual coordinate system. It should be noted that in (a) to (c) in FIG. 7, P2′ indicates the position of second member P2 when second image A2 is folded along boundary A3 in the Y-direction.

For instance, in (a) in FIG. 7, when second image A2 is folded along boundary A3 in the Y-direction, the position of first member P1 and the position of second member P2 match. Thus, the position correction amount is zero (no correction is to be performed).

Moreover, in (b) in FIG. 7, when second image A2 is folded along boundary A3 in the Y-direction, first member P1 is positioned further in the positive Y-direction than second member P2. Thus, the position correction amount is determined such that first member P1 is moved in the negative Y-direction.

Moreover, in (c) in FIG. 7, when second image A2 is folded along boundary A3 in the Y-direction, first member P1 is positioned further in the negative Y-direction than second member P2. Thus, the position correction amount is determined such that first member P1 is moved in the positive Y-direction.

The subsequent steps of step S4 are performed after the position correction amount is determined as above.

As described above, when prism 3 is disposed between head 5 and stage 6, first reflection surface 31 reflects light incident from the direction of head 5 toward camera 1, and second reflection surface 32 reflects light incident from the direction of stage 6 toward camera 1. On the basis of light incident from prism 3, camera 1 captures camera image A including first image A1 that is an image of the side where head 5 is located and second image A2 that is an image of the side where stage 6 is located. Computation equipment 8 determines the positions of first member P1 and second member P2 on the basis of camera image A. In this way, the positions of first member P1 and second member P2 can be recognized using one prism and one camera. Thus, it is possible to reduce the number of components included in the optical system. Accordingly, it is possible to suppress thermal expansion from occurring in the components included in the optical system, which can suppress the positioning accuracy from decreasing.

It should be noted that in Embodiment 1, first member P1 (or second member P2) may be large in size and extend beyond first image A1 (or second image A2). In this case, the optical system including camera 1 may be properly moved in the X-direction and Y-direction. Aa plurality of first images A1 (or a plurality of second images A2) may be generated. Computation equipment 8 may detect first characteristic point M1 (or second characteristic point M2) on the basis of the plurality of images.

### Embodiment 2

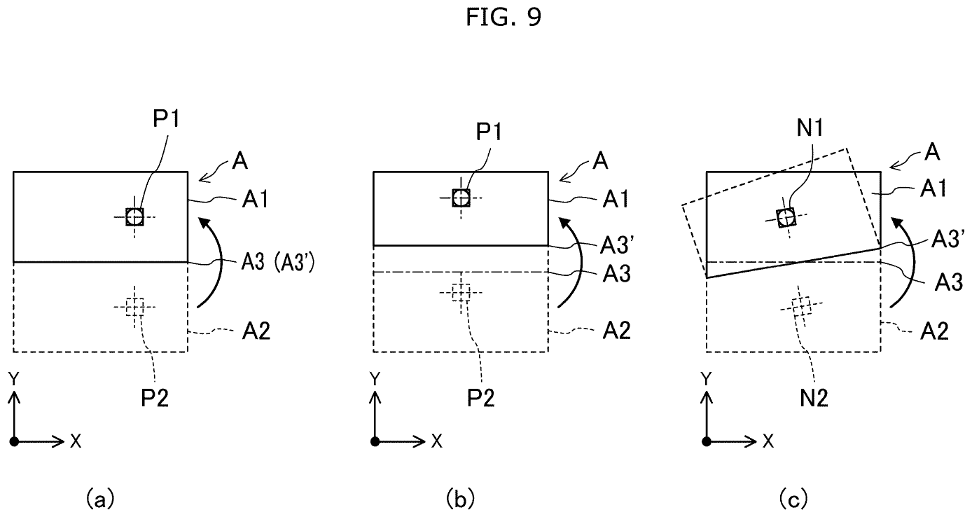

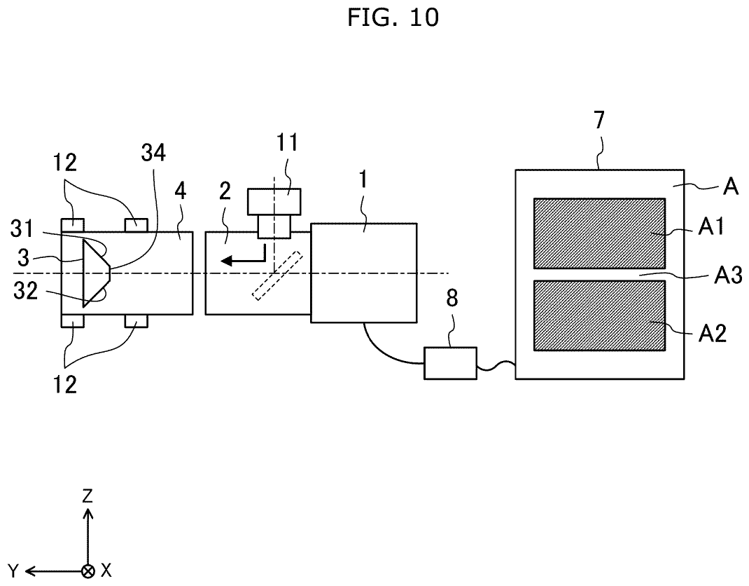

FIG. 8 is a flowchart illustrating processing for correcting a boundary position according to Embodiment 2. The operation indicated in FIG. 8 is performed by computation equipment 8 prior to the operation indicated in FIG. 4. In Embodiment 1, camera 1 is so provided that the upward direction from camera 1 matches the Z-direction, and prism 3 is so positioned that boundary line 33 between the two reflection surfaces (first reflection surface 31 and second reflection surface 32) of prism 3 is on the center of the optical axis of lens 2 and parallel to the X-axis. Thus, boundary A3 in camera image A (boundary line 33 of prism 3) is displayed such that boundary A3 is at the center in a vertical direction of camera image A and matches the X-direction (see each part of FIG. 6). However, camera image A may show boundary A3 misaligned from the position of boundary A3 in FIG. 6 (hereinafter, also referred to as the reference position of boundary A3) due to thermal expansion of the components included in the optical system (including camera 1 and lens 2). When the processing in FIGS. 4 and 5 is performed using misaligned boundary A3 as a reference, positioning of first member P1 and second member P2 (calculation of a correction amount) cannot be accurately performed. For this reason, in Embodiment 2, misalignment of boundary A3 is corrected by performing the processing for correcting the boundary position in FIG. 8. It should be noted that in (a) to (c) in FIG. 9, the boundary before the position correction is indicated as A3, and the boundary after the position correction is indicated as A3′.

First, computation equipment 8 detects boundary A3′ from camera image A (step S21). For instance, computation equipment 8 detects the bottom side of first image A1 and the top side of second image A2, and sets the intermediate position between the bottom side and the top side to boundary A3′. In this case, first image A1 and second image A2 may be captured separately, and computation equipment 8 may detect the bottom side of first image A1 and the top side of second image A2. Moreover, in camera image A, computation equipment 8 may detect, from a background image of a workpiece, the top side and bottom side of an area including boundary line 33 of prism 3 (an area where blur appears), and set the intermediate position between the top side and bottom side to boundary A3′.

Computation equipment 8 determines whether processing for correcting boundary A3 is necessary (step S22). Specifically, when boundary A3′ does not match the reference position of boundary A3 in camera image A, computation equipment 8 determines that processing for correcting boundary A3 is necessary.

When determining that the processing for correcting boundary A3 is not necessary (No in step S22), computation equipment 8 ends the processing. When determining that the processing for correcting boundary A3 is necessary (Yes in step S22), computation equipment 8 corrects the position of the boundary (step S23).

In the example illustrated in (a) in FIG. 9, since boundary A3′ matches the reference position of boundary A3 in camera image A, computation equipment 8 determines that the position correction of boundary A3 is not necessary (No in step S22). In this case, computation equipment 8 performs the processing indicated in FIG. 2 without performing the processing for correcting the position of boundary A3.

In the example illustrated in (b) in FIG. 9, boundary A3′ is misaligned from the reference position of boundary A3 in the positive Y-direction. For instance, camera image A1 as illustrated in (b) in FIG. 9 is obtained due to misalignment of the optical axis of lens 2 in the Z-direction.

In the example illustrated in (c) in FIG. 9, boundary A3′ is misaligned from the reference position of boundary A3 in a rotational direction about the center of camera image A1. For instance, camera image A1 as illustrated in (c) in FIG. 9 is obtained due to rotation of the optical axis of lens 2 about the Y-axis.

In (b) and (c) in FIG. 9, since boundary A3′ does not match the reference position of boundary A3 in camera image A, computation equipment 8 determines that the position correction of boundary A3 is necessary (Yes in step S22). Then, computation equipment 8 performs position correction processing for setting the position of boundary A3′ to the position of boundary A3 shown in camera image A. Thus, the processing following the position correction processing is performed using the position of boundary A3′ as a reference, the processing including, for example, calculation of a position correction amount in step S14 (e.g., processing for matching the coordinates of first image A1 and second image A2 with the actual coordinate system by folding second image A2 along boundary A3 in the Y-direction). Thus, if misalignment occurs in boundary A3 due to thermal expansion of the components included in the optical system including camera 1 and lens 2, it is possible to correct the position of each workpiece with high accuracy.

It should be noted that the position of boundary A3 significantly affects the calculation of the position correction amount in step S14. Moreover, in connecting a plurality of first members P1 to second member P2, during the multiple connection operations, the position of boundary A3 may change due to thermal expansion of the components included in the optical system. Thus, the processing indicated in FIG. 8 may be performed every predetermined number of connection operations or every predetermined period. In this case, the frequency of performing the processing indicated in FIG. 8 is determined according to, for example, a change in the temperature of the positioning device, the tendency of occurrence of misalignment of boundary A3, and the manufacturing speed of a finished product. The processing indicated in FIG. 8 may be a method capable of detecting boundary A3′ with high accuracy. However, if correction is necessary at a high frequency, it is practical to use the method together with a simple method. Moreover, the operation indicated in FIG. 8 may be performed at timing immediately before the connection operation, such as the restart timing of operation after a long period of suspension.

### Embodiment 3

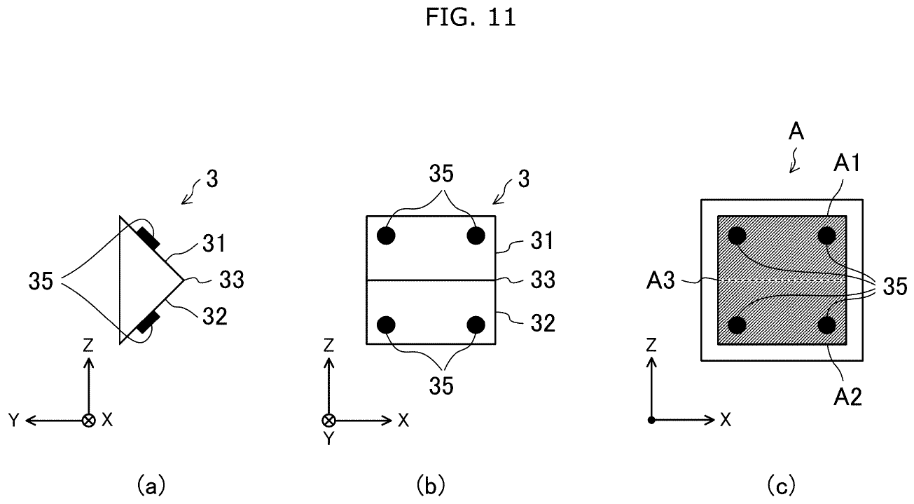

FIG. 10 is a side view of a positioning device according to Embodiment 3. Although the positioning device in FIG. 10 has almost the same configuration as the configuration illustrated in FIG. 1, the positioning device in FIG. 10 further includes coaxial lighting device 11 and oblique lighting device 12 (first lighting devices).

Coaxial lighting device 11 irradiates prism 3 with light in a Y-direction to irradiate first member P1 and second member P2 with light in a Z-direction. Oblique lighting device 12 obliquely irradiates first member P1 and second member P2 with light. Clearer camera image A can be captured by using coaxial lighting device 11 and oblique lighting device 12.

Here, prism 3 includes third reflection surface 34 between first reflection surface 31 and second reflection surface 32. Third reflection surface 34 has a predetermined width in the Z-direction, is a flat surface extending in an X-direction, and is formed as part of prism 3 instead of boundary line 33. By forming third reflection surface 34 as part of prism 3, boundary A3 is more clearly shown in camera image A. For instance, coaxial lighting device 11 is turned on, and camera 1 captures an image, in a state where there are no objects to be shown in first image A1 and second image A2. In this way, as illustrated in FIG. 10, first image A1 and second image A2 are captured as black images, and boundary A3 is shown between first image A1 and second image A2 as a white line. By treating the white line as boundary A3, the processing indicated in FIG. 8 can be performed more reliably.

It should be noted that third reflection surface 34 may have a width in the Z-direction which enables light reflected off third reflection surface 34 to be shown as one or more pixels of camera image A1 and as a portion less than 10% of the entire image. Moreover, as long as boundary A3 can be detected, the width of third reflection surface 34 in the Z-direction may correspond to less than one pixel.

### (Variation 1)

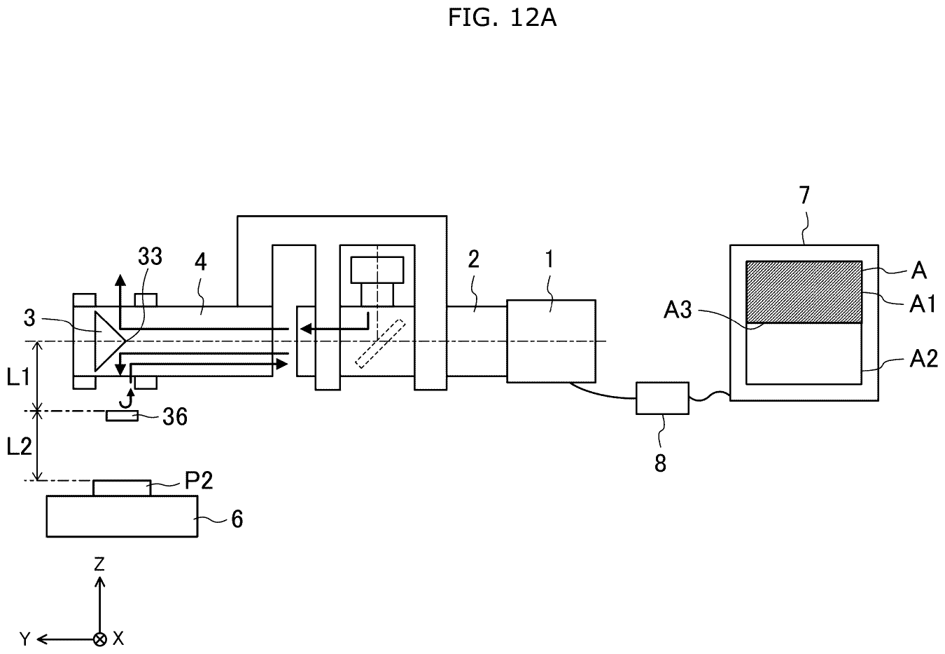

FIG. 11 is a figure for explaining another example of the prism according to Embodiment 3. Specifically, (a) in FIG. 11 is a side view of prism 3, and (b) in FIG. 11 is a view of prism 3 when viewed from lens 2.

In Variation 1, marks 35 (first marks) are provided on prism 3. Specifically, two marks 35 are provided on each of first reflection surface 31 and second reflection surface 32. Each mark 35 is so positioned that the distance from boundary line 33 to each mark 35 in the Z-direction is equal.

(c) in FIG. 11 is camera image A of prism 3 captured in a state where there were no objects to be shown in first image A1 and second image A2. As illustrated in (c) in FIG. 11, marks 35 are shown in camera image A. Thus, even when it is difficult to detect boundary A3, boundary A3 can be estimated to be present in the middle between two marks 35 vertically arranged in the figure, which enables detection of boundary A3.

It should be noted that the positions, types, and number of marks 35 are not limited to the example indicated in FIG. 11, and can be appropriately selected. Moreover, mark 35 may be a low-reflection member to be shown in camera image A at low luminance, and may be a high-reflection member to be shown in camera image A at high luminance.

### (Variation 2)

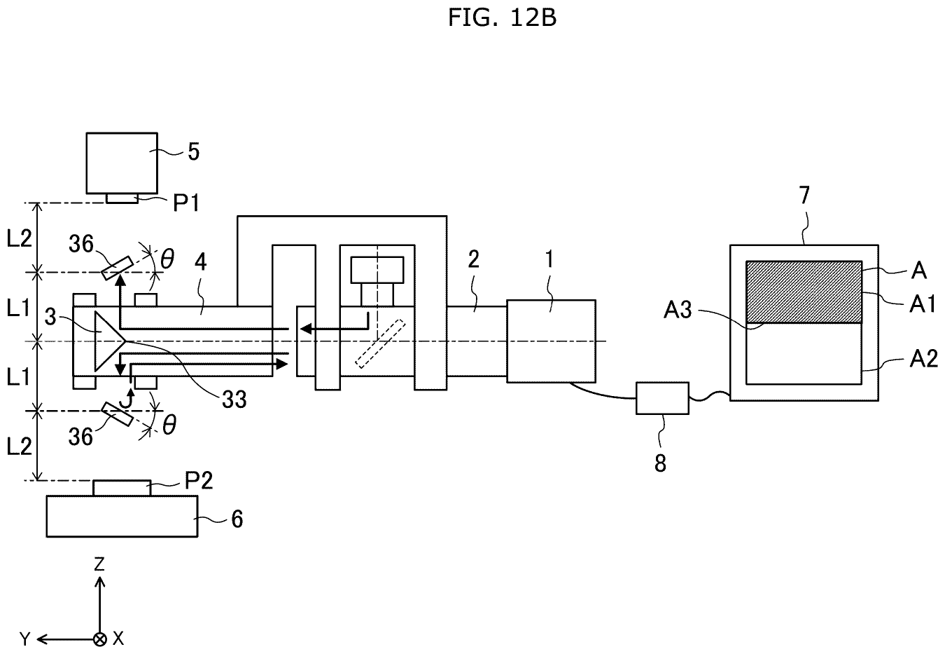

FIG. 12A is a side view of another example of the positioning device according to Embodiment 3.

In Variation 2, reflection plate 36 is disposed on the side where stage 6 is located, to detect boundary A3 in camera image A (boundary line 33). For instance, when camera 1 captures camera image A in a state where there are no objects to be shown in first image A1 and second image A2, no objects are present on the side where head 5 is located. Thus, a black image is shown in first image A1. By contrast, since reflection plate 36 is disposed on the side where stage 6 is located, a white image is shown in second image A2. At this time, the boundary between the black image (first image A1) and the white image (second image A2) can be estimated to be boundary A3 corresponding to boundary line 33. Thus, boundary A3 can be detected.

At this time, as illustrated in FIG. 12A, distance L1 from the position of the ridge line (boundary line 33) of prism 3 to the reflection surface of reflection plate 36 may be approximately the same as distance L2 from the reflection surface of reflection plate 36 to the imaging surface (the surface of second member P2 in FIG. 12A) of a workpiece that is an object of recognition. That is, reflection plate 36 may be located at the intermediate position approximately equidistant from (i) boundary line 33 between the first reflection surface and the second reflection surface of prism 3 and (ii) the position of the object of recognition. In this way, the focus of an obtained image matches the ridge line (boundary line 33) of prism 3, which in turn can detect boundary A3 more clearly. It should be noted that the degree of matching between distance L1 and distance L2 may be within the depth of field of lens 2.

It should be noted that a lighting device (a second light source) that irradiates prism 3 with light may be provided instead of reflection plate 36. Moreover, reflection plate 36 may be disposed on the side where head 5 is located.

Moreover, lighting devices (second light sources) may be provided above and below prism 3. In this case, as described above, computation equipment 8 detects the bottom side of first image A1 and the top side of second image A2, and recognizes, as boundary A3, the intermediate position between the bottom side and the top side. It should be noted that first image A1 and second image A2 may be captured separately, and computation equipment 8 may detect the bottom side of first image A1 and the top side of second image A2, and recognize, as boundary A3, the intermediate position between the bottom side and the top side.

Moreover, reflection plate 36 may be disposed on the head 5 side of prism 3 (the upper side in FIG. 12A), rather than being disposed on the stage 6 side of prism 3 (the lower side in FIG. 12A). As illustrated in FIG. 12B, reflection plates 36 may be disposed on both the stage 6 side and the head 5 side of prism 3. That is, reflection plate 36 may be disposed on at least one of the stage 6 side or head 5 side of prism 3.

In FIG. 12B, reflection plates 36 are provided above and below prism 3. In this case, reflection plate 36 may be inclined with an orientation of a very small inclination angle of θ. In this way, it is possible to clearly detect boundary line A3. Moreover, by adjusting inclination angle θ, it is possible to adjust the width of boundary line A3 to be detected. Also in this case, distance L1 and distance L2 may be equal. It should be noted that an inclination direction of reflection plate 36 (an angular direction of inclination angle θ) may be a direction that causes a portion of reflection plate 36 on the same side as prism 3 (on the opposite side from the camera) to be closer to prism 3. That is, reflection plate 36 may be inclined away from prism 3, with a portion of reflection plate 36 closer to camera 1 being farther from prism 3. Moreover, inclination angle θ of reflection plate 36 may range approximately from 0.05 deg to 0.1 deg. By slightly inclining reflection plate 36 in this manner, it is possible to detect boundary line A3 more clearly. However, the inclination direction and inclination angle of reflection plate 36 depend on the field of view. Thus, an inclination direction and an inclination angle are not limited to those described above. Moreover, when reflection plate 36 is disposed only above or below prism 3, when for instance the light amount of the coaxial lighting device is increased, boundary line A3 is detected with an expanded portion that is closer to the coaxial lighting device. However, as illustrated in FIG. 12B, by disposing reflection plate 36 both above and below prism 3, for example, if the light amount of the coaxial lighting device changes, there is only a change in the line width to be detected. As such, the position of boundary line A3 to be eventually calculated (the center line of the detected line) will not change. Because of this, the positioning device is less susceptible to light disturbance caused by lighting, which enables detection with high accuracy.

### (Variation 3)

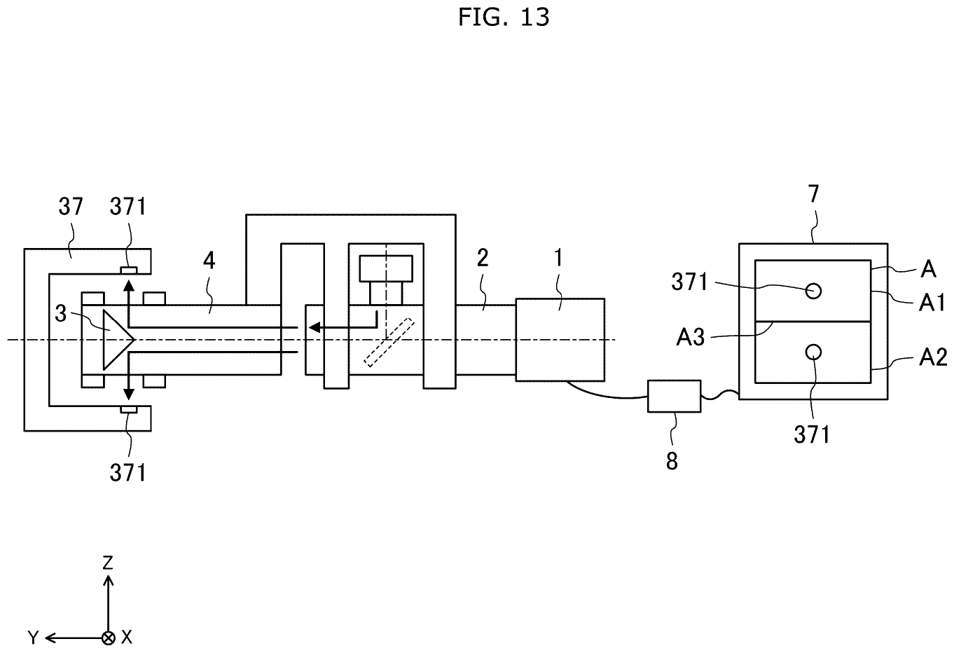

FIG. 13 is a side view of another example of the positioning device according to Embodiment 3.

In Variation 3, coaxial checking jig 37 (a first coaxial checking jig) is disposed to detect boundary A3 in camera image A (boundary line 33). Coaxial checking jig 37 is so disposed to interpose prism 3 in the Z-direction. Moreover, coaxial checking jig 37 is provided with marks 371 (second marks) provided at the same position in the X-direction and Y-direction.

As illustrated in FIG. 13, when camera 1 captures an image in a state where coaxial checking jig 37 is disposed, camera image A shows two marks 371. In coaxial checking jig 37, two marks 371 are provided at the same position in the X-direction and Y-direction. Thus, in camera image A, boundary A3 can be estimated to be present in the middle between marks 371. As such, boundary A3 can be detected.

### (Variation 4)

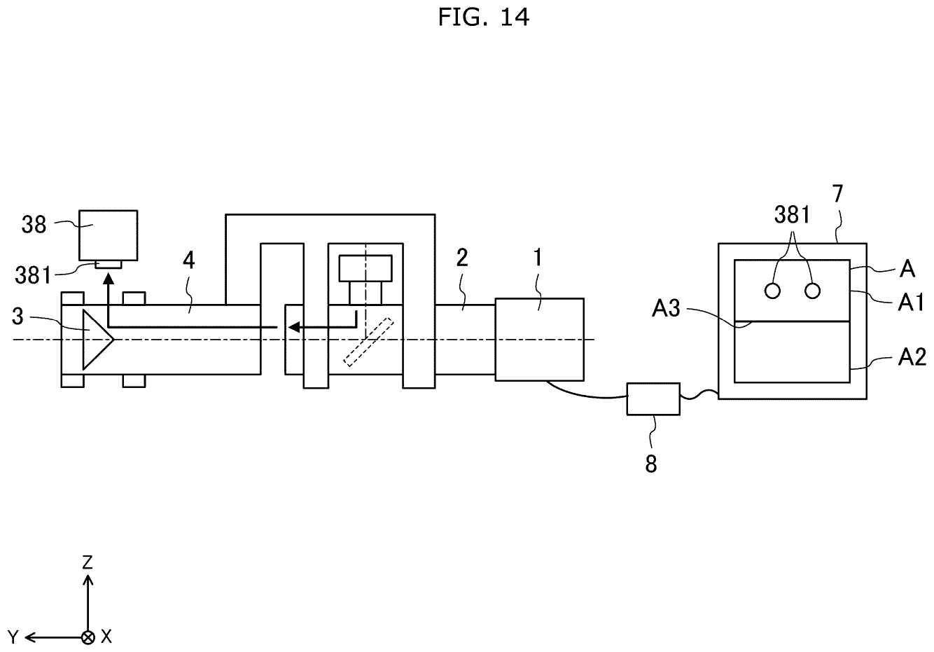

FIG. 14 is a side view of another example of the positioning device according to Embodiment 3.

In Variation 4, coaxial checking jig 38 (a second coaxial checking jig) is disposed to detect boundary A3 in camera image A (boundary line 33). Coaxial checking jig 38 is disposed on the side where head 5 is located. Moreover, coaxial checking jig 38 is provided with two marks 381 (third marks) arranged in the X-direction.

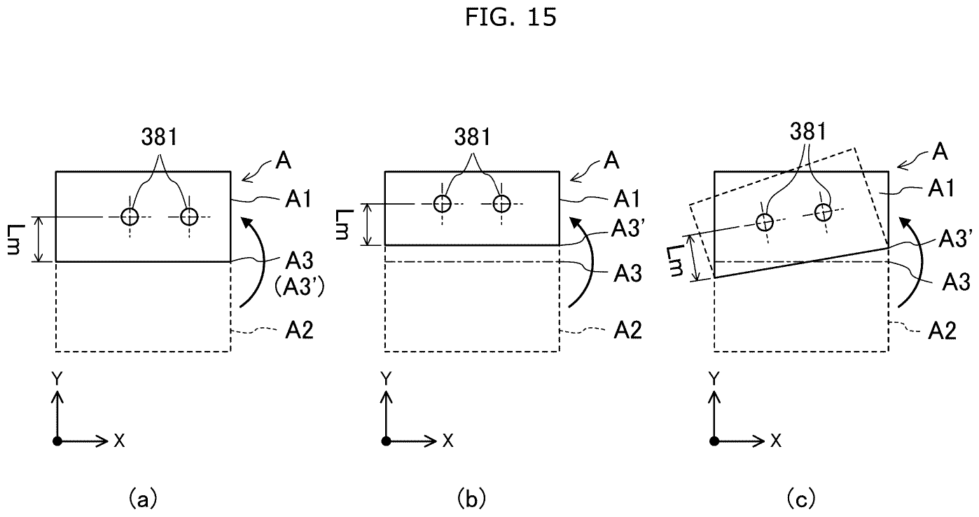

To detect boundary A3 in camera image A (boundary line 33), camera image A showing boundary A3 and two marks 381 is captured in advance, and boundary A3 and the initial positions of two marks 381 are obtained in advance. The position of boundary A3 can be corrected by comparing the initial positions of two marks 381 and the positions of marks 381 imaged afterward. Specifically, the relative distance between boundary A3 and the initial positions of two marks 381 (distance Lm in FIG. 15) is determined in advance. Boundary A3 is estimated to be present at an offset distance of Lm from a straight line connecting two marks 381 imaged afterward, in a direction perpendicular to the straight line. It should be noted that in (a) to (c) in FIG. 15, the boundary before the position correction is indicated as A3, and the boundary after the position correction is indicated as A3′.

For instance, when the optical axis of lens 2 shifts in the positive X-direction, two marks 381 misaligned in the positive X-direction are shown in first image A1 (see (a) in FIG. 15). In this case, boundary A3′ is estimated to be present at an offset distance of Lm from a straight line connecting two marks 381, in the negative Y-direction of the straight line.

Moreover, when the optical axis of lens 2 shifts in the positive Z-direction, two marks 381 misaligned in the positive Z-direction are shown in first image A1 (see (b) in FIG. 15). In this case, boundary A3′ is estimated to be present at an offset distance of Lm from a straight line connecting two marks 381, in the negative Z-direction of the straight line.

Moreover, when the optical axis of lens 2 is misaligned in a rotational direction about the Y-axis, two marks 381 misaligned in a rotational direction about the center in the figure (see (c) in FIG. 15) are shown in first image A1. In this case, boundary A3′ is estimated to be present at an offset distance of Lm from a straight line connecting two marks 381 in a direction perpendicular to the straight line.

Boundary A3 can be detected by performing the above processing.

It should be noted that even if prism 3 itself undergoes rotational deformation, by combining the methods for detecting boundary A3 described in Variation 4 and the other embodiments (and the other variations), the detection accuracy of boundary A3 can be improved.

### (Variation 5)

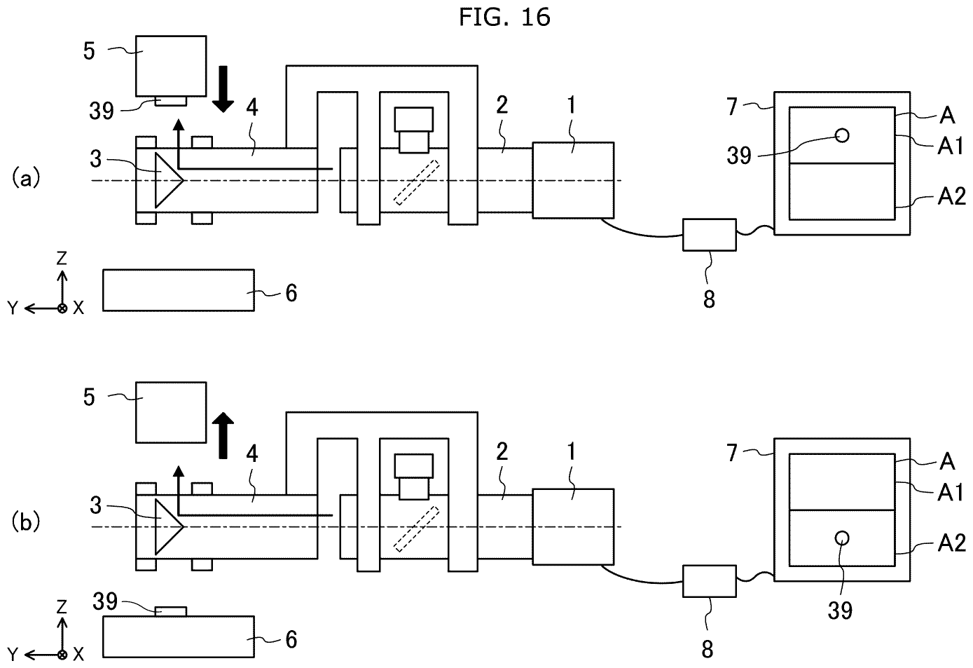

FIG. 16 is a side view of another example of the positioning device according to Embodiment 3.

In Variation 5, head 5 holds glass jig 39 to detect boundary A3 in camera image A (boundary line 33) (see (a) in FIG. 16).

To detect boundary A3 in camera image A (boundary line 33), first image A1 is captured in a state where glass jig 39 is held by head 5. Then, head 5 is moved in the Z-direction, and second image A2 is captured in a state where glass jig 39 is placed on stage 6 (see (b) in FIG. 16). At this time, boundary A3 can be estimated to be present at the intermediate position between glass jigs 39 shown in first image A1 and second image A2. Thus, boundary A3 can be detected.

### Other Embodiments

As described above, the embodiments are described as exemplifications of the techniques disclosed in the present application. However, the techniques in the present disclosure are not limited to those described in the embodiments, and the techniques are applicable to embodiments obtained by appropriately performing a change, replacement, addition, and omission, for example.

It should be noted that in the above embodiments, in performing combinational operation and detecting boundary A3, in some cases, head 5 is moved toward stage 6 in the Z-direction. In this case, an optical system (for example, camera 1, lens 2, prism 3, and prism holder 4) moves in the Y-direction or the X-direction (moves forward and moves backward), to prevent head 5 from hitting prism 3. At this time, the entire optical system may be moved. Alternatively, only prism 3 and prism holder 4 may move backward.

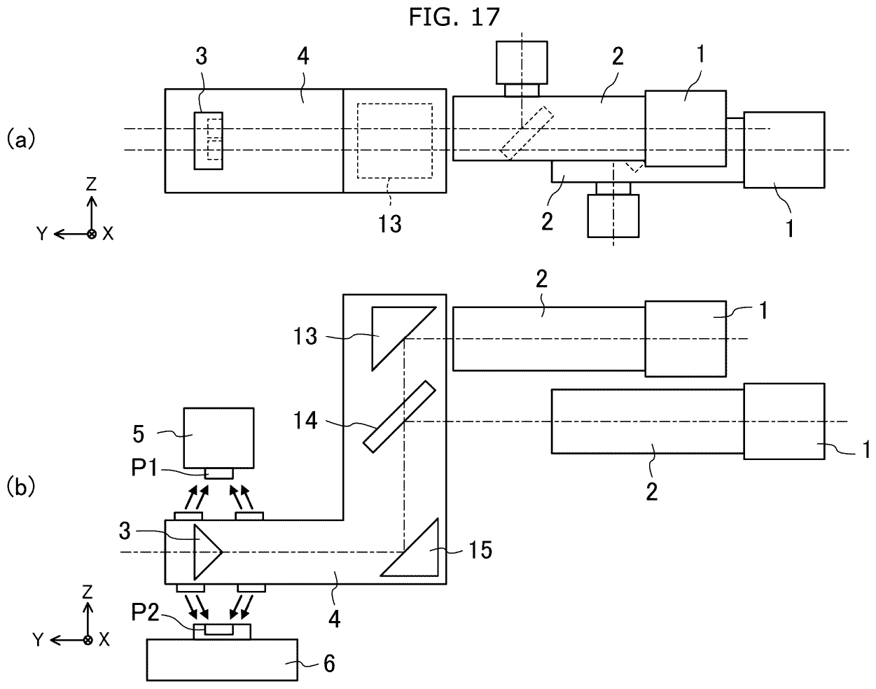

Moreover, in the above embodiments, a plurality of optical systems may be provided. (a) in FIG. 17 is a plan view of a positioning device, and (b) in FIG. 17 is a side view of the positioning device. As illustrated in FIG. 17, two each of camera 1, lens 2, prism 3, prism holder 4, and other components may be provided. Camera 1 positioned on the upper side images first member P1 and second member P2 via reflection prism 13, half mirror 14, reflection prism 15, and prism 3. Camera 1 positioned on the lower side images first member P1 and second member P2 via half mirror 14, reflection prism 15, and prism 3. In this configuration, cameras 1 capture camera images A showing portions at different positions in the X-direction. In this way, two or more portions of a workpiece can be imaged by performing image capturing one time, which can improve the producibility.

Moreover, in the above embodiments, as a non-limiting example, processing apparatus 100 including positioning device 10 is an imprint apparatus. For instance, processing apparatus 100 may be used in various apparatuses and equipment that require alignment between members, such as a processing apparatus and a manufacturing apparatus other than an imprint apparatus.

Moreover, in the above embodiments, as a non-limiting example, processing apparatus 100 as an imprint apparatus is used for making bumps on a substrate. Processing apparatus 100 as an imprint apparatus may be used for making a redistribution layer or may be used for making optical members, such as a light guide plate and an antireflection film in, for example, a liquid crystal display, optical components, such as a magnetic disk, a micro lens array, and an optical waveguide, a solar battery, a fuel cell member, a biodevice, or a semiconductor device.

It should be noted that the present disclosure also encompasses embodiments obtained by adding various changes envisioned by those skilled in the art to the above embodiments and embodiments achieved by optionally combining the constituent elements and functions described in the embodiments as long as the resultant embodiments do not depart from the scope of the present disclosure. Moreover, the present disclosure also encompasses optional combinations of two or more claims that are made, without having technical inconsistency, from the plurality of claims recited in the Claims of the application as originally filed. For instance, when the dependent claims recited in the Claims of the application as originally filed are formed as multiple dependent claims or multi-multi claims depending from all the preceding claims within the bounds of technical consistency, the present disclosure encompasses all the claim combinations included in the multiple dependent claims or multi-multi claims.

### INDUSTRIAL APPLICABILITY

The processing apparatus, the processing method, and other techniques described in the present disclosure can be used in positioning between members.

1. A processing apparatus comprising:
a head;
a stage;
a positioning device that performs positioning of a first member held by the head and a second member held by the stage when connecting the first member to the second member;
a prism including a first reflection surface and a second reflection surface;
a camera; and
computation equipment, wherein
when the prism is disposed between the head and stage, the first reflection surface reflects light incident from a direction of the head toward the camera, and the second reflection surface reflects light incident from a direction of the stage toward the camera,
based on light incident from the prism, the camera captures a camera image including a first image that is an image of a side where the head is located and a second image that is an image of a side where the stage is located, and
the computation equipment determines, based on the camera image, a position of the first member and a position of the second member.

2. The processing apparatus according to claim 1, further comprising:
a first light source that irradiates with light at least one of the first member held by the head or the second member held by the stage.

3. The processing apparatus according to claim 1, further comprising:
a lens disposed between the camera and the prism, wherein
the prism is so positioned that a distance between the prism and each of the first member and the second member is less than a distance between the prism and the lens.

4. The processing apparatus according to claim 1, comprising:
a plurality of cameras each of which is the camera, wherein
the plurality of cameras are so arranged as to capture camera images of portions at different positions of the head and portions at different positions of the stage, the camera images each being the camera image.

5. The processing apparatus according to claim 1, wherein
the prism includes a third reflection surface positioned between the first reflection surface and the second reflection surface and having a predetermined width,
the camera image shows a boundary between the first image and the second image, the boundary corresponding to the third reflection surface, and
the computation equipment determines the position of the first member and the position of the second member by using the boundary shown in the camera image as a reference.

6. The processing apparatus according to claim 1, wherein
a reflection plate that reflects light toward the prism is disposed on at least one of a head side or a stage side of the prism, the head side being the side where the head is located, the stage side being the side where the stage is located, and
the reflection plate is disposed at an intermediate position approximately equidistant from (i) a boundary line between the first reflection surface and the second reflection surface of the prism and (ii) a position of an object of recognition.

7. The processing apparatus according to claim 1, wherein
a reflection plate that reflects light toward the prism is disposed on each of a head side and a stage side of the prism, the head side being the side where the head is located, the stage side being the side where the stage is located,
the reflection plate is disposed at an intermediate position approximately equidistant from (i) a boundary line between the first reflection surface and the second reflection surface of the prism and (ii) a position of an object of recognition, and
the reflection plate is inclined away from the prism, with a portion of the reflection plate closer to the camera being farther from the prism.

8. The processing apparatus according to claim 1, wherein
the processing apparatus is an imprint apparatus.

9. A processing method comprising:
a process of performing positioning of a first member and a second member when connecting the first member to the second member; and
a process of connecting the first member to the second member, wherein
the process of performing the positioning includes:
causing a head to hold the first member;
causing a stage to hold the second member;
locating a prism between the head and the stage;
reflecting, by a first reflection surface of the prism, light incident from a direction of the head toward a camera, and reflecting, by a second reflection surface of the prism, light incident from a direction of the stage toward the camera;
causing the camera to capture, based on light incident from the prism, a camera image including a first image that is an image of a side where the head is located and a second image that is an image of a side where the stage is located; and
causing computation equipment to determine, based on the camera image, a position of the first member and a position of the second member.

10. The processing method according to claim 9, wherein
the processing method is a manufacturing method for manufacturing an electronic component.
